(19) United States
(12) Patent Application Publication
(10) Pub. No.: US 2024/0241701 A1
(43) Pub. Date: Jul. 18, 2024

(54) TECHNIQUES FOR A CLOUD SCIENTIFIC MACHINE LEARNING PROGRAMMING ENVIRONMENT

(71) Applicant: DEEP FOREST SCIENCES, INC.

(72) Inventors: BHARATH RAMSUNDAR, Palo Alto, CA (US); ARUN PALANIAPPAN TR, Mountain View, CA (US)

(73) Assignee: DEEP FOREST SCIENCES, INC., (omitted)

(21) Appl. No.: 18/414,136

(22) Filed: Jan. 16, 2024

Related U.S. Application Data
(60) Provisional application No. 63/438,902, filed on Jan. 13, 2023.

(51) Int. Cl. G06F 8/36; G06F 11/34

(52) U.S. Cl. CPC G06F 8/36; G06F 11/3433

(57) ABSTRACT

Various aspects of the present disclosure relate to techniques for a cloud scientific machine learning programming environment. An apparatus includes at least one memory and at least one processor coupled to the memory and configured to cause the apparatus to receive a request to perform a machine learning task, analyze the machine learning task to determine one or more functions for performing the machine learning task, generate a workflow for the one or more functions of the machine learning task, execute the generated workflow, and provide results of the executed workflow.

### CROSS-REFERENCE TO RELATED APPLICATIONS

This application claims the benefit of U.S. Provisional Patent Application No. 63/438,902 entitled “A CLOUD SCIENTIFIC MACHINE LEARNING PROGRAMMING ENVIRONMENT” and filed on Jan. 13, 2023, for Bharath Ramsundar et al., which is incorporated herein by reference.

### FIELD

This invention relates to machine learning and more particularly relates to techniques for a cloud scientific machine learning programming environment.

### BACKGROUND

Machine learning may be used to process large data sets for a variety of applications. Scientists struggle to use machine learning for scientific applications, however, due to the difficulty of curating training data, training scientific machine learning models, evaluating these models, and then deploying them to design subsequent experimental steps.

### SUMMARY

Various aspects of the present disclosure relate to techniques for a cloud scientific machine learning programming environment. An apparatus includes at least one memory and at least one processor coupled to the memory and configured to cause the apparatus to receive a request to perform a machine learning task, analyze the machine learning task to determine one or more functions for performing the machine learning task, generate a workflow for the one or more functions of the machine learning task, execute the generated workflow, and provide results of the executed workflow.

A method for a cloud scientific machine learning programming environment includes receiving a request to perform a machine learning task, analyzing the machine learning task to determine one or more functions for performing the machine learning task, generating a workflow for the one or more functions of the machine learning task, executing the generated workflow, and providing results of the executed workflow.

A computer program product includes instructions that are stored on a storage medium and that are executable by a processor for receiving a request to perform a machine learning task, analyzing the machine learning task to determine one or more functions for performing the machine learning task, generating a workflow for the one or more functions of the machine learning task, executing the generated workflow, and providing results of the executed workflow.

An apparatus includes means for receiving a request to perform a machine learning task, analyzing the machine learning task to determine one or more functions for performing the machine learning task, generating a workflow for the one or more functions of the machine learning task, executing the generated workflow, and providing results of the executed workflow.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates one example of a system for a cloud scientific machine learning programming environment, in accordance with the subject matter described herein;

FIG. 2 illustrates one example of an apparatus for a cloud scientific machine learning programming environment, in accordance with the subject matter described herein;

FIG. 3 illustrates an example script for a cloud scientific machine learning programming environment, in accordance with the subject matter described herein;

FIG. 4 illustrates an example system for a cloud scientific machine learning programming environment, in accordance with the subject matter described herein;

FIG. 5A illustrates a diagram showing an example scenario where users and organizations have profiles for a cloud scientific machine learning programming environment, in accordance with the subject matter described herein;

FIG. 5B illustrates a diagram showing an example scenario where a profile has multiple projects for a cloud scientific machine learning programming environment, in accordance with the subject matter described herein;

FIG. 5C illustrates a diagram showing an example scenario where a project can have multiple users which do not own the project but collaborate on the effort for a cloud scientific machine learning programming environment, in accordance with the subject matter described herein; and

FIG. 6 illustrates a schematic flow chart diagram for one embodiment of a method for a cloud scientific machine learning programming environment, in accordance with the subject matter described herein.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

In one embodiment, the subject matter herein is directed to a system that facilitates no-code development and deployment of scientific machine learning models. In general, the system, in one embodiment, allows scientists to upload data, access relevant datasets and pre-trained machine learning models, perform sophisticated scientific workflows, and run large scale virtual experiments to guide future rounds of scientific experiments. In one embodiment, the system enables easy collaboration between scientists by providing an organization/project system, e.g., similar to Github, for scientific collaborations within and across teams, and also features an extensive application programming interface (“API”) of scientific machine learning functions and workflows.

At its core, in one embodiment, the system includes a computational engine for performing scientific computations. In certain embodiments, the system facilitates heavy scientific computations and analyses such as building scientific machine learning models, molecular docking, molecular dynamics, density functional theory, free energy perturbation simulations, and/or the like by providing a scalable and programmable cloud backend. The system backend, in one embodiment, is programmed in a proprietary programming language, a domain specific language for specifying large scale scientific workflows.

This disclosure is directed to techniques for a cloud scientific machine learning programming environment, including programming scientific workflows. This includes providing access to pretrained foundation models, datasets, and a rich scientific API, along with details of the organization/project collaboration structure, and a cloud storage datastore.

As used herein, artificial intelligence (“AI”) is broadly defined as a branch of computer science dealing in automating intelligent behavior. AI systems may be designed to use machines to emulate and simulate human intelligence and corresponding behavior. This may take many forms, including symbolic or symbol manipulation AI. AI may address analyzing abstract symbols and/or human readable symbols. AI may form abstract connections between data or other information or stimuli. AI may form logical conclusions. AI is the intelligence exhibited by machines, programs, or software. AI has been defined as the study and design of intelligent agents, in which an intelligent agent is a system that perceives its environment and takes actions that maximize its chances of success.

AI may have various attributes such as deduction, reasoning, and problem solving. AI may include knowledge representation or learning. AI systems may perform natural language processing, perception, motion detection, and information manipulation. At higher levels of abstraction, it may result in social intelligence, creativity, and general intelligence. Various approaches are employed including cybernetics and brain simulation, symbolic, sub-symbolic, and statistical, as well as integrating the approaches.

Various AI tools may be employed, either alone or in combinations. The tools may include search and optimization, logic, probabilistic methods for uncertain reasoning, classifiers and statistical learning methods, neural networks, deep feedforward neural networks, deep recurrent neural networks, deep learning, control theory and languages.

Machine learning (“ML”) plays an important role in a wide range of critical applications with large volumes of data, such as data mining, natural language processing, image recognition, voice recognition and many other intelligent systems. There are some basic common threads about the definition of ML. As used herein, ML is defined as the field of study that gives computers the ability to learn without being explicitly programmed. For example, when predicting traffic patterns at a busy intersection, it is possible to run through a machine learning algorithm with data about past traffic patterns. The program can correctly predict future traffic patterns if it learned correctly from past patterns.

There are different ways an algorithm can model a problem based on its interaction with the experience, environment, or input data. The machine learning algorithms may be categorized so that it helps to think about the roles of the input data and the model preparation process leading to correct selection of the most appropriate category for a problem to get the best result. Known categories are supervised learning, unsupervised learning, semi-supervised learning, and reinforcement learning.
(a) In supervised learning category, input data is called training data and has a known label or result. A model is prepared through a training process where it is required to make predictions and is corrected when those predictions are wrong. The training process continues until the model achieves a desired level of accuracy on the training data. Example problems are classification and regression.
(b) In unsupervised learning category, input data is not labelled and does not have a known result. A model is prepared by deducing structures present in the input data. Example problems are association rule learning and clustering. An example algorithm is k-means clustering.
(c) Semi-supervised learning falls between unsupervised learning (without any labeled training data) and supervised learning (with completely labeled training data). Researchers found that unlabeled data, when used in conjunction with a small amount of labeled data may produce considerable improvement in learning accuracy.
(d) Reinforcement learning is another category which differs from standard supervised learning in that correct input/output pairs are never presented. Further, there is a focus on on-line performance, which involves finding a balance between exploration for new knowledge and exploitation of current knowledge already discovered.

Certain machine learning techniques are widely used and are as follows: Decision tree learning, Association rule learning, Artificial neural networks, Inductive logic programming, Support vector machines, Clustering, Bayesian networks, Reinforcement learning, Representation learning, and Genetic algorithms.

The learning processes in machine learning algorithms are generalizations from past experiences. After having experienced a learning data set, the generalization process is the ability of a machine learning algorithm to accurately execute on new examples and tasks. The learner needs to build a general model about a problem space enabling a machine learning algorithm to produce sufficiently accurate predictions in future cases. The training examples come from some generally unknown probability distribution.

In theoretical computer science, computational learning theory performs computational analysis of machine learning algorithms and their performance. The training data set is limited in size and may not capture all forms of distributions in future data sets. The performance is represented by probabilistic bounds. Errors in generalization are quantified by bias-variance decompositions. The time complexity and feasibility of learning in computational learning theory describes a computation to be feasible if it is done in polynomial time. Positive results are determined and classified when a certain class of functions can be learned in polynomial time whereas negative results are determined and classified when learning cannot be done in polynomial time.

In one embodiment, an apparatus includes at least one memory and at least one processor coupled to the memory and configured to cause the apparatus to receive a request to perform a machine learning task, analyze the machine learning task to determine one or more functions for performing the machine learning task, generate a workflow for the one or more functions of the machine learning task, execute the generated workflow, and provide results of the executed workflow.

In one embodiment, the at least one processor is configured to cause the apparatus to determine one or more requirements for performing the one or more functions of the workflow.

In one embodiment, the at least one processor is configured to cause the apparatus to identify one or more nodes for performing the one or more functions of the workflow based on the one or more requirements and transmit the workflow to the identified one or more nodes for performing the one or more functions of the workflow.

In one embodiment, the at least one processor is configured to cause the apparatus to containerize at least a portion of the one or more functions of the workflow prior to transmitting the workflow to the one or more nodes.

In one embodiment, the containerized workflow comprises a command script comprising instructions for performing the one or more functions of the workflow. In one embodiment, the at least one processor is configured to cause the apparatus to store the dataset, the results, model inputs, model outputs, or a combination thereof, in dedicated storage associated with the workflow.

In one embodiment, the at least one processor is configured to cause the apparatus to read and write data to the dedicated storage during execution of the workflow. In one embodiment, the dedicated storage associated with the workflow comprises a shared address space that is available to users who are members of a same organization. In one embodiment, the at least one processor is configured to cause the apparatus to determine a cost for executing the workflow prior to executing the workflow.

In one embodiment, the at least one processor is configured to cause the apparatus to present a prompt for approval to proceed with execution of the workflow in response to the determined cost satisfying a threshold cost. In one embodiment, the at least one processor is configured to cause the apparatus to generate one or more visualizations associated with the workflow. In one embodiment, the one or more visualizations comprises an interactive molecular visualization that allows real-time editing of a molecule.

In one embodiment, the at least one processor is configured to cause the apparatus to generate one or more checkpoints during execution of the workflow. In one embodiment, the at least one processor is configured to cause the apparatus to restart the workflow at a checkpoint of the one or more checkpoints in response to execution of the workflow being interrupted.

In one embodiment, the machine learning task is associated with at least one user, at least one team, at least one organization, or a combination thereof. In one embodiment, the machine learning task is shareable across a plurality of users, teams, organizations, or a combination thereof.

In one embodiment, the machine learning task comprises a scientific machine learning task utilizing one or more scientific machine learning models. In one embodiment, the scientific machine learning task comprises a chemistry-related machine learning task. In one embodiment, the one or more scientific machine learning models comprises one or more chemistry foundation machine learning models.

In one embodiment, the at least one processor is configured to cause the apparatus to add one or more new functions to a core set of functions used to perform machine learning tasks. In one embodiment, the at least one processor is configured to cause the apparatus to receive the request to perform the machine learning task via a shared application programming interface (API).

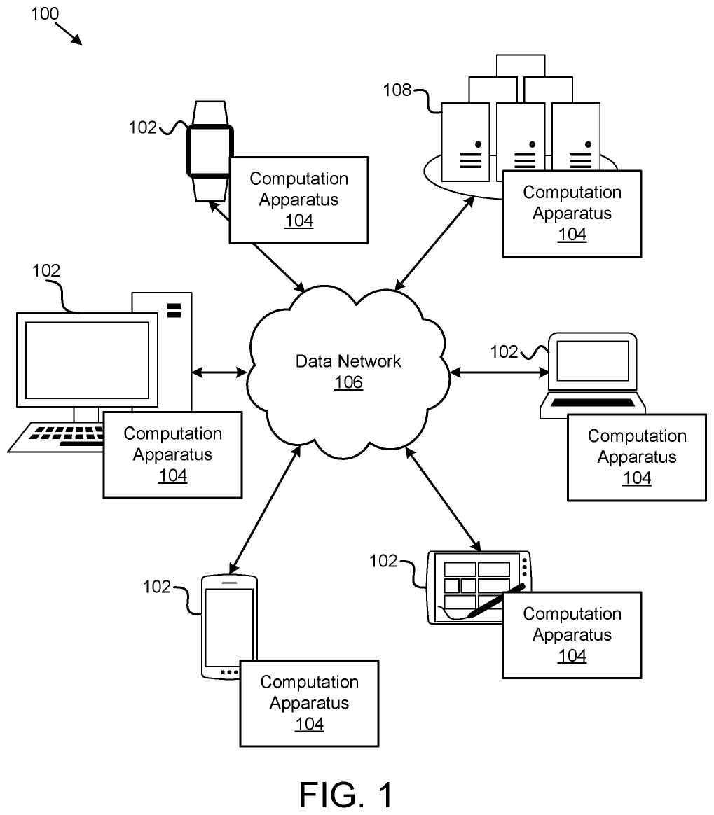

FIG. 1 is a schematic block diagram illustrating one embodiment of a system 100 for foundation model based fluid simulations. In one embodiment, the system 100 includes one or more information handling devices 102, one or more computation apparatuses 104, one or more data networks 106, and one or more servers 108. In certain embodiments, even though a specific number of information handling devices 102, computation apparatuses 104, data networks 106, and servers 108 are depicted in FIG. 1, one of skill in the art will recognize, in light of this disclosure, that any number of information handling devices 102, computation apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, are configured to execute various programs, program code, applications, instructions, functions, and/or the like, which may access, store, download, upload, and/or the like data located on one or more servers 108. The information handling devices 102 may include one or more hardware and software components for training, implementing, deploying, and processing fluid foundation models and corresponding data.

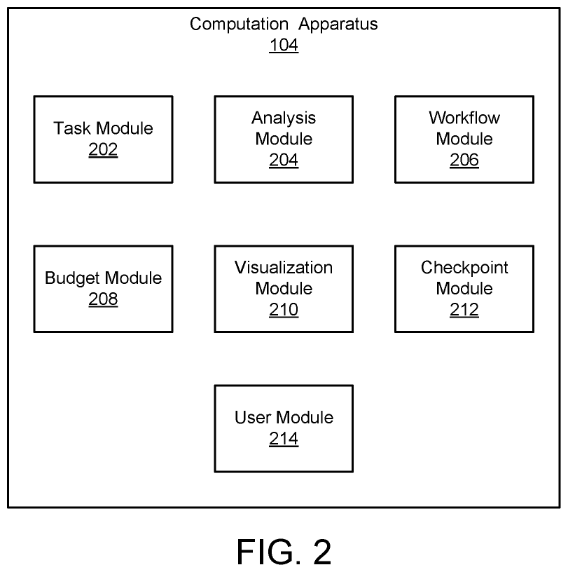

In general, the computation apparatus 104 is configured to receive a request to perform a machine learning task using a dataset, analyze the machine learning task to determine the functions, e.g., operations, instructions, calls, or the like, that are needed to perform the machine learning tasks, and generate a workflow for the functions such that the functions are performed in an order using machine learning models and the dataset (e.g., inputting or providing the dataset to the machine learning models). The computation apparatus 104, in one embodiment, executes the workflow and provides the results. The computation apparatus 104 is described in more detail below with reference to FIG. 2.

In various embodiments, the computation apparatus 104 may be embodied as a hardware appliance that can be installed or deployed on an information handling device 102, on a server 108, or elsewhere on the data network 106. In certain embodiments, the computation apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the computation apparatus 104 may include a power interface, a wired and/or wireless network interface, a graphical interface that attaches to a display, and/or a semiconductor integrated circuit device as described below, configured to perform the functions described herein with regard to the computation apparatus 104.

The computation apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the computation apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the computation apparatus 104.

The semiconductor integrated circuit device or other hardware appliance of the computation apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the computation apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (IEEE) 802.11 standards. Alternatively, the wireless connection may be a Bluetooth® connection. In addition, the wireless connection may employ a Radio Frequency Identification (RFID) communication including RFID standards established by the International Organization for Standardization (ISO), the International Electrotechnical Commission (IEC), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (IrPHY) as defined by the Infrared Data Association® (IrDAR). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102.

FIG. 2 depicts one embodiment of an apparatus 200 for techniques for a cloud scientific machine learning programming environment. In one embodiment, the apparatus 200 includes an instance of an computation apparatus 104. The computation apparatus 104 may include one or more of a task module 202, an analysis module 204, a workflow module 206, a budget module 208, a visualization module 210, a checkpoint module 212, and a user module 214, which are described in more detail below.

In one embodiment, the task module 202 is configured to receive a request to perform a machine learning task, job, routine, program, script, process, applications, function, instruction, and/or the like. As used herein, the machine learning task may refer to a set of instructions for performing a task that utilizes machine learning algorithms, models, or the like. The task module 202 may receive the request to perform the machine learning task via an API, command line interface (CLI), graphical user interface (GUI), or the like.

In one embodiment, tasks may be run in a separate cloud cluster, such as AWS Batch or a Kubernetes cluster. When the task is launched, started, or the like (e.g., as a workflow described below), in one embodiment, a docker image is fetched from a cloud docker repository. The image may then be executed as a container in a cloud instance. The instance type (e.g., number of CPUs, GPUs, memory, or the like) can be configured using job configuration IDs that can be specified during submissions of tasks.

In one embodiment, tasks submitted by users can have dependencies, e.g., functions, primitives, or the like. Task dependencies can be used to create a chain, which performs an analysis workflow (described below). Tasks may be launched by the main server, which, in one embodiment, may receive a web API request for a computational machine learning task and launch batch tasks to a cloud backend. Tasks that are created may have an associated unique identifier.

Computational tasks may be run as batch jobs. When a user submits a task, an AWS batch job may be launched to execute the task. Users can specify job configuration and job dependencies. A log of jobs submitted by the user can be retrieved, e.g., using an API. In one embodiment, the task module 202 tracks the history of tasks submitted for each user, allowing for a programmatic reconstruction of scientific workflows and increased scientific reproducibility. Commands that are generated may be automatically logged into the database. This history, in one embodiment, automatically functions as an observatory notebook containing the scientific workflow carried out by the user.

In one embodiment, the task module 202 receives a dataset as part of the request. The dataset may be provided to, input into, or the like the machine learning models that are used to perform the task. The dataset may be used for other purposes as well, including statistical analyses, or other processing. The dataset may include experimental data, simulation data, data describing physical laws, and/or the like. The request may further include a desired outcome or goal, constraints, limitations, or the like on the computations.

For example, the task module 202 may receive a request to perform a drug discovery task, a molecular modeling task, a task to perform a battery electrolyte design, and/or another scientific-based task that requires various machine learning models such as foundation machine learning models. As used herein, foundation machine learning models may refer to machine learning models that have been trained on large amounts of data and can perform a variety of tasks. Foundation models may be based on complex neural networks, including transforms generative adversarial networks, and variation encoders. The dataset may be raw data file, a comma-separated values (CSV) file, a database, or the like that may include various types of data including integers, real numbers, characters, strings, and/or a combination thereof.

In one embodiment, an analysis module 204 is configured to analyze the machine learning task to determine one or more functions, instructions, calls, or the like for performing the machine learning task. As used herein, the one or more functions that comprise the machine learning task may be referred to herein as primitives. For instance, the machine learning task may include a featurization task, a task to train a machine learning model using the dataset, a large scale inference task, or the like and the functions (primitives) for performing the task may include feat( ), train( ), infer( ), cluster( ), query( ), dock( ), and/or the like.

In one embodiment, the functions are predefined by the analysis module 204 for use in the system 100. For instance, the machine learning task may be defined using a predefined, internal, domain-specific, or proprietary programming language for the system 100. The programming language, in one embodiment, is a workflow language with a strong type system and is built out of a set of core scientific functions/primitives. In other embodiments, a user may create or define their own functions using the programming language.

As used herein, primitives are tokens in the grammar of the programming language that correspond to functions that implement a scientifically relevant operation such as training a machine learning model, running a molecular dynamics simulation, or computing a retrosynthetic route. A side-effect of primitives occurs in a datastore (a shared storage space, described below). Primitives, in one embodiment, accept a dataset/model address (which points to a file/directory in the datastore) as input and operate on it, perform computation, and write results back to the datastore, without changing any global state outside the datastore. In one embodiment, the structure of the primitives is extensible and modular such that new primitives comprising new machine learning or numerical operations can be added to the core system without affecting existing primitives.

The programming language, in one embodiment, is strongly typed to estimate effective budget estimates for the cost of scientific programs through its type system (see below). The analysis module 204 uses types to track and infer the type, size, and shape of data. The programming language, in one embodiment, is composed of primitive functions that implement core scientific operations and workflows. The type system, in one embodiment, tracks the size and form of inputs and outputs to scientific primitives. Each primitive may be associated with a budget or a cost by the programming language (see below).

The programming language, in one embodiment, provides easy access to pretrained scientific foundation models. Using primitives, users can train a machine learning model to perform learning on a scientific dataset, like a dataset of molecules, and perform inference with a single line query. Programs, in one embodiment, are stored with a ‘.ch’ file extension and can be submitted programmatically through an API, e.g., a Python API or through a UI, e.g., a web interface or gateway.

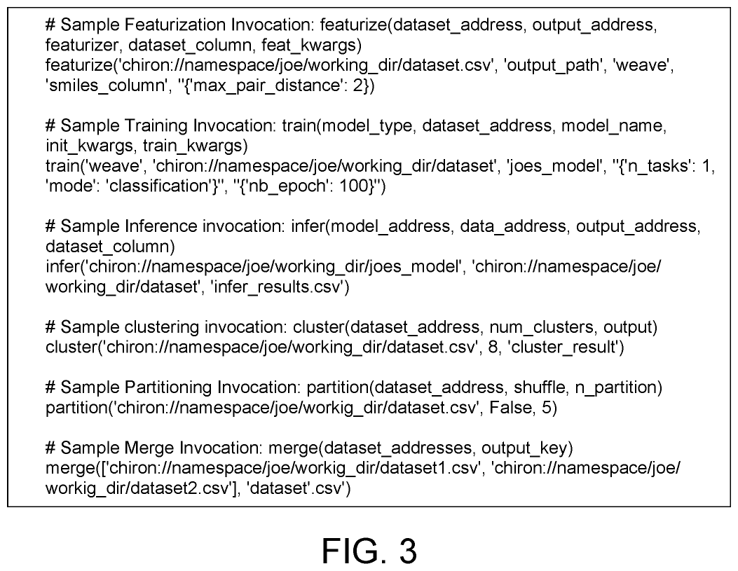

One benefit of using the programming language, in one embodiment, is that the programming language is directly connected to the backend, which takes care of managing cloud resources and infrastructure for large scale workflows. FIG. 3 depicts one embodiment of a script that shows an example embodiment of a program written in the programming language.

In one embodiment, primitives may be shared by both a frontend and an API such as a programmatic Representational State Transfer (REST) API, a Python API (using Python scripts), or the like. The design of core primitives, in one embodiment, is the heart of the API in the system 100 and makes it possible to construct sophisticated scientific workflows by composing primitive calls. In one embodiment, primitives are designed to chain together to construct more sophisticated workflows.

In one embodiment, the workflow module 206 is configured to generate a workflow for the one or more functions of the machine learning task. As used herein, a workflow may refer to a computational job, flow, or the like that includes an order for performing the one or more functions for the machine learning task using one or more machine learning models and the dataset. The order may be sequential, chronological, or the like.

The machine learning models may comprise foundation models. The foundation models may be stored in a repository and may be selected for use during execution of the workflow. The pretrained, foundation models may allow users, e.g., scientists, to make progress with limited data. These pretrained models may include large transformer models that are trained on large datasets, either public or proprietary. Pretrained foundation models may be made publicly accessible through their addresses if their project setting enables sharing.

In one embodiment, workflow module 206 is configured to determine one or more requirements for performing the one or more functions of the workflow. The requirements may include resources or capabilities (e.g., CPU, GPU, memory, network bandwidth, or the like), software, hardware, or other capabilities of a device. In such an embodiment, the workflow module 206 may identify and select one or more nodes for performing the one or more functions of the workflow based on the one or more requirements. The nodes may include computing devices such as cloud or remote computing devices, data centers, end user devices, and/or the like. The nodes may have different capabilities or requirements, and the workflow module 206 may be configured to determine which nodes are best suited for performing the functions of the workflow based on the requirements of the workflow. Once the nodes have been identified, the workflow module 206 transmits the workflow to the identified nodes for performing the one or more functions of the workflow.

In one embodiment, the workflow module 206 may execute a workflow on a dedicated or default node that is always available for running workflows, e.g., so that the user does not have to wait and/or pay to spin up a new node for a particular workflow. For example, if the machine learning task includes an analysis of a small data set that falls within the resources and capabilities available by the default node, then the workflow module 206 may run the workflow on the default node instead of using the resources, time, energy, and cost to identify, set up, spin up, and use a new node.

In one embodiment, the workflow module 206 is integrated with a cloud backend to enable spinning up and shutting down large-scale workflows. In such an embodiment, the workflow module 206 can be connected to various cloud service providers to perform computation. For example, the workflow module 206 may be connected to Amazon Web Services, Microsoft Azure, or another cloud system. For machine learning training workflows, systems like Kubernetes may be used to handle workflows. Thus, in one embodiment, users don't need to maintain infrastructure for machine learning tasks and can focus on their scientific tasks.

In one embodiment, the workflow module 206 is configured to containerize at least a portion of the one or more functions of the workflow prior to transmitting the workflow to the one or more nodes. As used herein, a container may refer to a standard unit of software that packages up code and all its dependencies so the application, job, task, process, or the like, runs quickly and reliably from one computing environment to another. Containers isolate software from its environment and ensure that it works uniformly despite differences, e.g., configuration differences between nodes.

In such an embodiment, the workflow module 206 may generate or include a command script within the container that includes the instructions, commands, or the like for processing the workflow, e.g., for running the functions that comprise the workflow. The command script may be generated using the programming language for the system 100, described above. In further embodiments, during execution of the containerized workflow, the workflow module 206 may provide status updates, progression toolbars, progression statistics, or the like as feedback to a user or a system on the progress of the workflow.

In one embodiment, the workflow module 206 provides or transmits the results of the executed workflow. For instance, the workflow module 206 may transmit the results directly to a user (e.g., via an API or other message), or may store the results in the datastore and provide a link or address to the user for accessing or viewing the results, and/or the like. In other words, datasets, model inputs, and model outputs may be stored in a shared address space that is dedicated to the workflow, organization, team, user, task, or the like. Members of the same organization would then have access to a shared organizational address space which can be used to share models, inputs, and outputs across the team.

The datastore may be used to store the dataset that is sent as part of the request for the machine learning task, to store the results of the workflow, and/or the like. For instance, during execution of the workflow, the workflow module 206 may read and write data to a dedicated storage location, partition, drive, area, or the like for the workflow. The datastore may isolate data for a user, a team, an organization, a project, a task, a workflow, or the like from other data so that one dataset is not co-located with another dataset. In certain embodiments, each node or container receives its own dedicated storage. In further embodiments, a user has control over its data storage and can flush or delete the data from the datastore, can download the data, can view the data, and/or the like.

In one embodiment, files associated with a project are stored in a cloud storage backend. In one embodiment, when a user uploads data to the datastore, it is stored in an underlying cloud storage system, e.g., an AWS S3 bucket. Along with the data itself, a data card containing metadata about the dataset may be generated and stored. The dataset, in one embodiment, is assigned a unique address that can be used to reference the dataset. In one embodiment, machine learning models built by the user are also stored in the datastore along with user data. In one embodiment, users may choose to make their datastores publicly accessible. In such an embodiment, arbitrary users (who may not have a user account) can download and access models/datasets from this project through the API.

In one embodiment, the budget module 208 is configured to determine a cost for executing the workflow prior to executing the workflow. The budget module 208, in one embodiment, predicts, estimates, forecasts, or the like the cost of executing a workflow preemptively before running the workflow. The budget module 208, in one embodiment, may provide a warning, notification, or the like if executing the workload is estimated to exceed a threshold budget/cost. In further embodiments, the budget module 208 may present a prompt for approval to proceed with execution of the workflow in response to the determined cost satisfying a threshold cost so that users don't accidentally spend large amounts of money when doing large scale computation.

In one embodiment, the budget module 208 derives the cost of a task or workflow from metadata stored in the data cards or model cards for datasets models used in the workflow. As used herein, a model card includes metadata for a machine learning model including details about potential uses of the model, the dataset in which the model was trained upon, potential causes of bias in the model, the validation loss of the model, and/or the like. A data card, as used herein, may refer to metadata about a dataset uploaded to the datastore. A data card may contain metadata information like the number of entries in a dataset, its attributes, the type of values in the dataset, the purpose of the dataset, how the dataset was created, and/or the like. The data cards may also contain other metadata like how the dataset was generated and what processing methods were used to generate the dataset.

Each primitive, in one embodiment, has a fixed cost which is proportional to the time taken to perform the computation for a fixed number of datapoints. In one embodiment, the cost of the job is then proportional to the size of dataset in which the operation is being performed multiplied by the cost of the primitive used for operation. The budget module 208 may further derive the cost of a task or workflow based on historical usage, historical workflows, node resources, data size, computation time, and/or the like.

In one embodiment, the budget module 208 provides a token credit system for running workflows within the system 100. For instance, every primitive may have an associated cost, e.g., a static analysis of the command, function, instruction, that is provided. The dataset may also have a cost that depends on its size. The budget module 208 may use a set of rules to determine how much execution of the workflow will cost depending on the functions/primitives that comprise the workflow, the size of the dataset, and/or the like.

To estimate the cost, the budget module 208, in one embodiment, parses the functions/primitives of the workflow, generates an abstract syntax tree, and analyzes the rules for each operation. For each data point in the dataset, the budget module 208 may determine the processing needed and the associated cost (e.g., based on a linear function for each primitive). The costs may be allocated per data point and may be different for each data point depending on the processing/computation needed for each data point. The costs may also be impacted by the node that is used to execute the workflow. For instance, a node with more resources, with newer resources, and/or the like may cost more than a node with limited or older resources.

In one embodiment, the visualization module 210 is configured to generate one or more visualizations associated with the workflow. The visualizations may include graphical images, videos, graphs, charts, models, plots, plans, CAD models, and/or the like. The visualizations may be interactive such that the user can interact with the visualization using touch input, mouse input, keyboard input, voice input, motion input, and/or the like.

For instance, the visualization module 210 may use a display engine to present visualizations of proteins, molecules, DNA sequences, or the like. In such an embodiment, the visualization module 210 may receive user input, such as drag and drop actions, within the interactive visualization to edit the visualization. For example, the visualization module 210 may present a chemical editor that a user can interact with to edit a molecule (e.g., add or remove atoms) using drag and drop or other input actions, in real time.

In one embodiment, the checkpoint module 212 is configured to generate one or more checkpoints during execution of the workflow. For instance, if the estimated computation time for a workflow satisfies a threshold computation time, e.g., hours, days, weeks, or the like, the checkpoint module 212 may create one or more checkpoints during execution of the workflow. As used herein, a checkpoint may refer to the process of saving a snapshot of the workflow state, so that the workflow can restart from that point in case of failure or other interruption.

In one embodiment, the checkpoint module 212 stores the generated checkpoints in the datastore associated with the dataset, the workflow, the node, and/or the like. The checkpoint module 212, in one embodiment, in the event of a failure or interruption, is configured to automatically restart the workflow at a checkpoint of the one or more checkpoints in response to execution of the workflow being interrupted. In such an embodiment, the checkpoint module 212 may trigger spinning up a new node and continuing the workflow on the new node from the checkpoint without requiring input or intervention from the user.

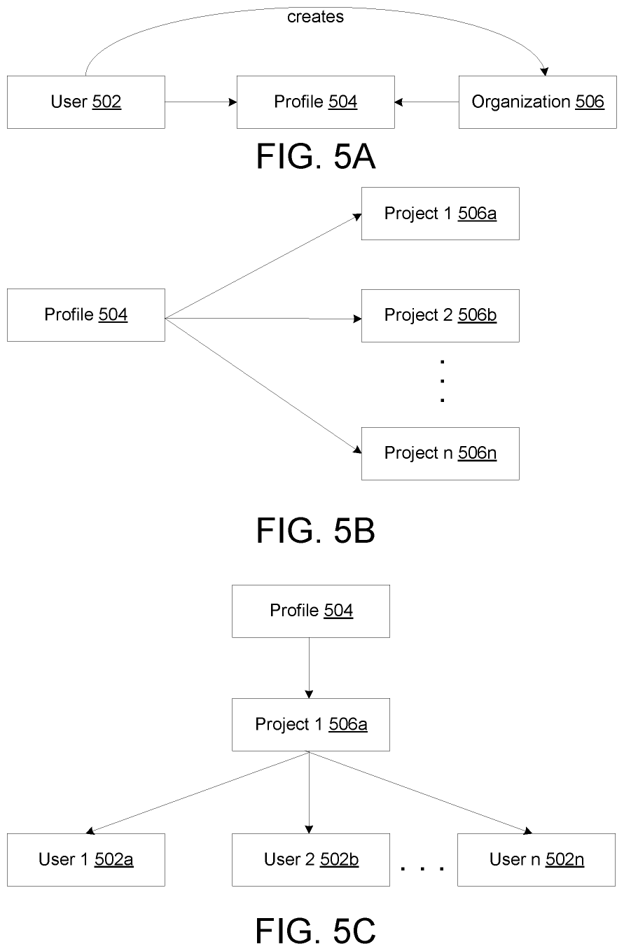

In one embodiment, the user module 214 is configured to assign, associate, or otherwise logically connect a task, workflow, or the like with a user, a team of users, a department, an organization, and/or the like. In such an embodiment, the user module 214 creates an organizational structure, e.g., similar to other tools in software development like Github, with a breakdown into organizations and projects. Each user may belong to multiple projects, and both organizations and users can own projects. Multiple users can collaborate on a project. In this manner, tasks such as scientific projects and workflows can be distributed to teams to coordinate scientific work. In one embodiment, the user module 214 assigns projects, tasks, workflows, or the like to profiles. Both organizations and users can have profiles. Multiple users may collaborate on a project, as described below with reference to FIGS. 5A-5C.

In one embodiment, each instance of the computation apparatus 104 is called a “server”. In one embodiment, a server may be roughly analogous to, or substantially similar to, a Discord server or a Mastodon Instance and corresponds to a copy of the server run by an organization. An organization, such as Deep Forest Sciences, may run the main server, but may launch other servers for customers who wish to have an on-premises deployment of the server within their infrastructure. In such an embodiment, user accounts are tracked globally and are valid across servers. In one embodiment, the main server run by the organization, e.g., Deep Forest Sciences, manages the global user database along with information about all running servers.

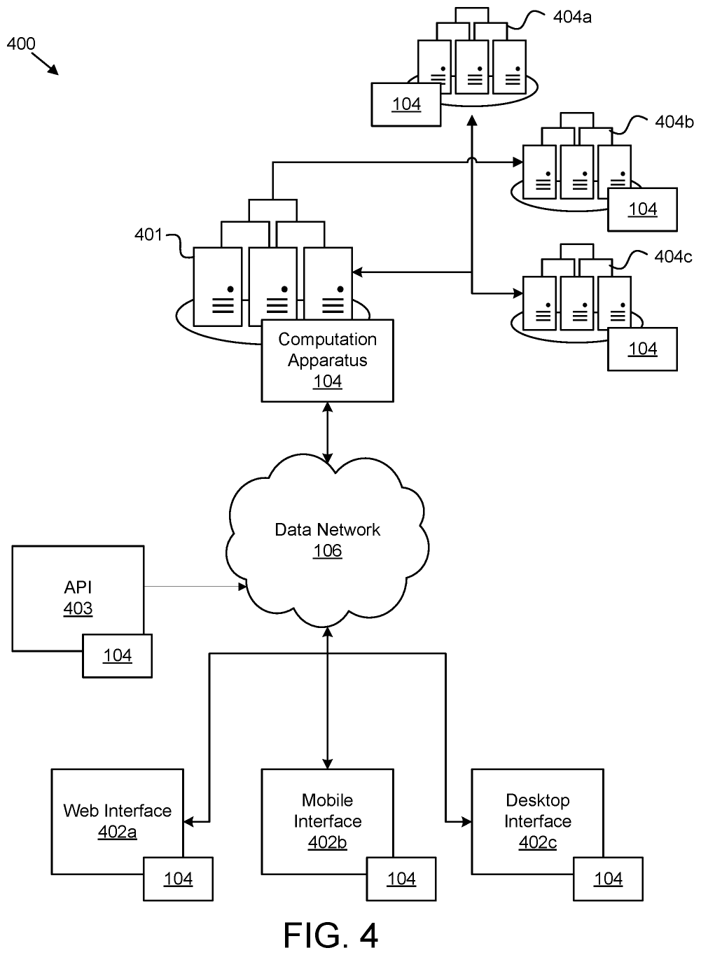

FIG. 4 depicts one example embodiment of a system 400 for techniques for a cloud scientific machine learning programming environment. In one embodiment, the computation apparatus 104 is integrated with a cloud backend 401 to enable spinning up and shutting down large-scale workflows on cloud nodes 404a-404c (collectively 404). In one embodiment, users, e.g., scientists, submit machine learning tasks or jobs from either a frontend user interface (e.g., a web interface 402a via a browser, a mobile application 402b, a desktop application 402c (collectively 402), or the like), or an API 403 such as a programmatic python API, and tasks are executed on the cloud nodes 404, which may include various cloud computing services such as Amazon Web Services, or the like.

In one embodiment, users submit requests to perform machine learning tasks via a UI 402 or an API 403. The task module 202 may receive the request, at the cloud backend 401, including any data that is to be processed/analyzed as part of the request. The machine learning tasks may include featurization, training on datasets, large scale inference, or the like. The computation apparatus 104 provides support for building a wide range of machine learning models such as graph convolutions, ensemble models, and feature support for training scientific foundation models like Grover, ChemBERTa, ProBERTa, or the like. The computation apparatus 104 also supports running scientific workflows like large-scale docking, molecular dynamics, and free energy perturbation.

In one embodiment, the analysis module 204 located on the cloud backend 401 analyzes the machine learning task to determine one or more functions for performing the machine learning task. In one embodiment, the workflow module 206 on the cloud backend 401 generates a workflow for the one or more functions of the machine learning task and determines one or more cloud nodes 404 for executing the workflow.

In an example embodiment, the system 400 and computation apparatus 104 may be utilized for drug discovery. Drug discovery is typically a long and complex process that requires significant time and resources. The pharmaceutical industry has historically depended on an expensive trial-and-error process that tests large numbers of compounds in the lab to identify potential drug candidates. The process is expensive and time consuming. The full pipeline has very low yield, with tens of thousands (or even millions or billions) of compounds tested to produce a single clinical candidate, and a 90% failure rate between entering the clinic and reaching patients.

The computation apparatus 104 described herein uses AI and scientific machine learning algorithms to accelerate the drug discovery process. More specifically, in one embodiment, the computation apparatus 104 analyzes biological and chemical datasets in order to build machine learned models that can identify small molecule hits and optimize small molecule leads. The computation apparatus 104, in one embodiment, leverages pre-trained chemical foundation models to lower data requirements for practical drug discovery. In one embodiment, the computation apparatus 104 helps predict the efficacy of potential compounds, identify potential side effects, and prioritize compounds to test in secondary assays.

The computation apparatus 104 as described herein, in one embodiment, can be sued to perform structural analysis of targets and identify potential binding sites for a more targeted design process, build models based on early assay or patient data to use in large scale virtual screens for hit finding, construct active learning pipelines to identify and confirm high quality hits, and/or suggest modifications to increase the potency, selectivity, and safety of hits. The computation apparatus 104, in one embodiment, leverages pre-trained foundation models to help systematically lower data requirements so biotech teams can start to leverage AI earlier in their design process.

The computation apparatus 104, in one embodiment, uses a powerful scientific machine learning engine that enables users to run sophisticated scientific calculations without writing new code. The computation apparatus 104, in one embodiment, features proprietary datasets and models that users can license to bootstrap their AI efforts before building in-house datasets. The computation apparatus 104, in one embodiment, may include out-of-box or predefined workflows for running large scale virtual screens against vendor catalogs, constructing active learning pipelines for hit finding, running large scaling docking analyses, running free energy perturbation workflows, fine-tuning pretrained chemical foundation models for ADMET/QSAR modeling, running hyperparameter optimization to build high-quality models, and/or the like.

In one embodiment, the computation apparatus 104 is built around the DeepChem ecosystem, an open source framework for molecular drug discovery and scientific machine learning. DeepChem offers a wide range of tools and models for scientific machine learning and deep learning, enabling researchers to predict properties, perform virtual screening, and conduct molecular featurization. The computation apparatus 104, in one embodiment, puts the DeepChem stack into production and extends the DeepChem stack to handle real-world drug discovery. The computation apparatus 104, in one embodiment, leverages its cloud infrastructure to train models and gather datasets at an industrial scale not feasible with vanilla DeepChem. By harnessing chemical foundation models such as ChemBERTa, the computation apparatus 104 can leverage vast unlabeled datasets of chemical structures to unlock AI methods in real-world drug discovery even with limited data.

In another example embodiment, a user may want to use the computation apparatus 104 to perform molecular modeling, create a new machine learning model, perform statistical validation on the dataset, e.g., estimate true positive/false positive rate, and/or the like. The user may upload a dataset and request to generate or create a molecule with predefined properties. The computation apparatus 104 may receive the request and the dataset, determine the functions that are needed to process the request, generate a workflow for the request, and execute the workflow using one or more machine learning models. In such an embodiment, the machine learning models may be trained on molecular data such as vendor catalogs of molecules, internet or research sources, or the like. The computation apparatus 104 may further provide for post-processing of the results including filter the results, eliminate outlier data, cluster data, and/or the like, as it relates to the molecular modeling.

FIG. 5A depicts a scenario where both users 502 and organizations 506 have profiles 504, and profiles 504 may own projects, tasks, workflows, or the like. FIG. 5B depicts a scenario where each profile 504 can own any number of projects 506a-n, tasks, workflows, or the like and users 502 may also join projects 506a-n, tasks, workflows, or the like, that they don't own. FIG. 5C depicts a scenario where a profile 504 for projects 506a-n, tasks, workflows, or the like can have multiple users 502a-n that do not own the projects 506a-n, tasks, workflows, or the like, but collaborate on the effort.

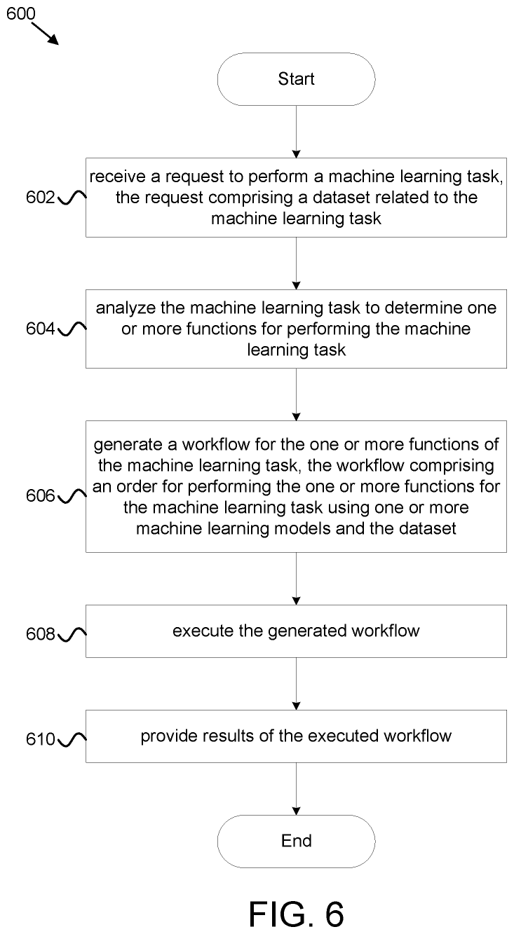

FIG. 6 depicts one embodiment of method 600 for techniques for a cloud scientific machine learning programming environment. The method 600 may be performed by a backend computing device, a backend server, a cloud device, an computation apparatus 104, a task module 202, an analysis module 204, a workflow module 206, and/or the like.

In one embodiment, the method 600 begins and receives 602 a request to perform a machine learning task, the request comprising a dataset related to the machine learning task. In one embodiment, the method 600 analyzes 604 the machine learning task to determine one or more functions for performing the machine learning task. In one embodiment, the method 600 generates 606 a workflow for the one or more functions of the machine learning task, the workflow comprising an order for performing the one or more functions for the machine learning task using one or more machine learning models and the dataset. In one embodiment, the method 600 executes 608 the generated workflow and provides 610 results of the executed workflow, and the method 600 ends.

A means for receiving a request to perform a machine learning task, in various embodiments, may include one or more of an information handling device 102, a backend server 108, an computation apparatus 104, a task module 202, a processor (e.g., a CPU, a processor core, an FPGA or other programmable logic, an ASIC, a controller, a microcontroller, and/or another semiconductor integrated circuit device), a network interface, an HDMI or other electronic display dongle, a hardware appliance or other hardware device, other logic hardware, and/or other executable code stored on a computer readable storage medium. Other embodiments may include similar or equivalent means for receiving a request to perform a machine learning task.

A means for analyzing the machine learning task to determine one or more functions for performing the machine learning task, in various embodiments, may include one or more of an information handling device 102, a backend server 108, an computation apparatus 104, an analysis module 204, a processor (e.g., a CPU, a processor core, an FPGA or other programmable logic, an ASIC, a controller, a microcontroller, and/or another semiconductor integrated circuit device), a network interface, an HDMI or other electronic display dongle, a hardware appliance or other hardware device, other logic hardware, and/or other executable code stored on a computer readable storage medium. Other embodiments may include similar or equivalent means for analyzing the machine learning task to determine one or more functions for performing the machine learning task.

A means for generating a workflow for the one or more functions of the machine learning task, executing the generated workflow, and providing results of the executed workflow, in various embodiments, may include one or more of an information handling device 102, a backend server 108, an computation apparatus 104, a workflow module 206, a processor (e.g., a CPU, a processor core, an FPGA or other programmable logic, an ASIC, a controller, a microcontroller, and/or another semiconductor integrated circuit device), a network interface, an HDMI or other electronic display dongle, a hardware appliance or other hardware device, other logic hardware, and/or other executable code stored on a computer readable storage medium. Other embodiments may include similar or equivalent means for generating a workflow for the one or more functions of the machine learning task, executing the generated workflow, and providing results of the executed workflow.

A means for determining a cost for executing the workflow prior to executing the workflow, in various embodiments, may include one or more of an information handling device 102, a backend server 108, an computation apparatus 104, a budget module 208, a processor (e.g., a CPU, a processor core, an FPGA or other programmable logic, an ASIC, a controller, a microcontroller, and/or another semiconductor integrated circuit device), a network interface, an HDMI or other electronic display dongle, a hardware appliance or other hardware device, other logic hardware, and/or other executable code stored on a computer readable storage medium. Other embodiments may include similar or equivalent means for determining a cost for executing the workflow prior to executing the workflow.

A means for generating one or more visualizations associated with the workflow, in various embodiments, may include one or more of an information handling device 102, a backend server 108, an computation apparatus 104, a visualization module 210, a processor (e.g., a CPU, a processor core, an FPGA or other programmable logic, an ASIC, a controller, a microcontroller, and/or another semiconductor integrated circuit device), a network interface, an HDMI or other electronic display dongle, a hardware appliance or other hardware device, other logic hardware, and/or other executable code stored on a computer readable storage medium. Other embodiments may include similar or equivalent means for generating one or more visualizations associated with the workflow.

A means for generating one or more checkpoints during execution of the workflow, in various embodiments, may include one or more of an information handling device 102, a backend server 108, an computation apparatus 104, a checkpoint module 212, a processor (e.g., a CPU, a processor core, an FPGA or other programmable logic, an ASIC, a controller, a microcontroller, and/or another semiconductor integrated circuit device), a network interface, an HDMI or other electronic display dongle, a hardware appliance or other hardware device, other logic hardware, and/or other executable code stored on a computer readable storage medium. Other embodiments may include similar or equivalent means for generating one or more checkpoints during execution of the workflow.

A means for performing other functions described herein, may include one or more of an information handling device 102, a backend server 108, an computation apparatus 104, a task module 202, an analysis module 204, a workflow module 206, a budget module 208, a visualization module 210, a checkpoint module 212, a user module 214, a processor (e.g., a CPU, a processor core, an FPGA or other programmable logic, an ASIC, a controller, a microcontroller, and/or another semiconductor integrated circuit device), a network interface, an HDMI or other electronic display dongle, a hardware appliance or other hardware device, other logic hardware, and/or other executable code stored on a computer readable storage medium.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
at least one memory; and
at least one processor coupled to the memory and configured to cause the apparatus to:
receive a request to perform a machine learning task, the request comprising a dataset related to the machine learning task;
analyze the machine learning task to determine one or more functions for performing the machine learning task;
generate a workflow for the one or more functions of the machine learning task, the workflow comprising an order for performing the one or more functions for the machine learning task using one or more machine learning models and the dataset;
execute the generated workflow; and
provide results of the executed workflow.

2. The apparatus of claim 1, wherein the at least one processor is configured to cause the apparatus to determine one or more requirements for performing the one or more functions of the workflow.

3. The apparatus of claim 2, wherein the at least one processor is configured to cause the apparatus to:
identify one or more nodes for performing the one or more functions of the workflow based on the one or more requirements; and
transmit the workflow to the identified one or more nodes for performing the one or more functions of the workflow.

4. The apparatus of claim 3, wherein the at least one processor is configured to cause the apparatus to containerize at least a portion of the one or more functions of the workflow prior to transmitting the workflow to the one or more nodes, the containerized workflow comprising a command script comprising instructions for performing the one or more functions of the workflow.

5. The apparatus of claim 1, wherein the at least one processor is configured to cause the apparatus to store the dataset, the results, model inputs, model outputs, or a combination thereof, in dedicated storage associated with the workflow.

6. The apparatus of claim 5, wherein the at least one processor is configured to cause the apparatus to read and write data to the dedicated storage during execution of the workflow.

7. The apparatus of claim 5, wherein the dedicated storage associated with the workflow comprises a shared address space that is available to users who are members of a same organization.

8. The apparatus of claim 1, wherein the at least one processor is configured to cause the apparatus to determine a cost for executing the workflow prior to executing the workflow.

9. The apparatus of claim 8, wherein the at least one processor is configured to cause the apparatus to present a prompt for approval to proceed with execution of the workflow in response to the determined cost satisfying a threshold cost.

10. The apparatus of claim 1, wherein the at least one processor is configured to cause the apparatus to generate one or more visualizations associated with the workflow.

11. The apparatus of claim 1, wherein the at least one processor is configured to cause the apparatus to generate one or more checkpoints during execution of the workflow.

12. The apparatus of claim 11, wherein the at least one processor is configured to cause the apparatus to restart the workflow at a checkpoint of the one or more checkpoints in response to execution of the workflow being interrupted.

13. The apparatus of claim 1, wherein the machine learning task is associated with at least one user, at least one team, at least one organization, or a combination thereof.

14. The apparatus of claim 13, wherein the machine learning task is shareable across a plurality of users, teams, organizations, or a combination thereof.

15. The apparatus of claim 1, wherein the machine learning task comprises a scientific machine learning task utilizing one or more scientific machine learning models.

16. The apparatus of claim 15, wherein the scientific machine learning task comprises a chemistry-related machine learning task and wherein the one or more scientific machine learning models comprises one or more chemistry foundation machine learning models.

17. The apparatus of claim 1, wherein the at least one processor is configured to cause the apparatus to add one or more new functions to a core set of functions used to perform machine learning tasks.

18. The apparatus of claim 1, wherein the at least one processor is configured to cause the apparatus to receive the request to perform the machine learning task via a shared application programming interface (API).

19. A method, comprising:
receiving a request to perform a machine learning task, the request comprising a dataset related to the machine learning task;
analyzing the machine learning task to determine one or more functions for performing the machine learning task;
generating a workflow for the one or more functions of the machine learning task, the workflow comprising an order for performing the one or more functions for the machine learning task using one or more machine learning models and the dataset;
executing the generated workflow; and
providing results of the executed workflow.

20. An apparatus, comprising:
means for receiving a request to perform a machine learning task, the request comprising a dataset related to the machine learning task;
means for analyzing the machine learning task to determine one or more functions for performing the machine learning task;
means for generating a workflow for the one or more functions of the machine learning task, the workflow comprising an order for performing the one or more functions for the machine learning task using one or more machine learning models and the dataset;
means for executing the generated workflow; and
means for providing results of the executed workflow.
